(19) United States
(12) Patent Application Publication
(10) Pub. No.: US 2010/0031232 A1
(43) Pub. Date: Feb. 4, 2010

(54) Creating deployable software code for implementing a business process using a library of preconfigured processes

(76) Inventors: Jason Glazier, (US); Stephen F. DeAngelis, (US); Daniel T. Mascenik, (US); Richard G. Helsen, (US); Peter Wagner, (US); Eric Wiseblatt, (US); Danja Spoja, (US)

Correspondence Address: K&L GATES LLP, 535 SMITHFIELD STREET, PITTSBURGH, PA, 15222, US

(21) Appl. No.: 12/082,146

(22) Filed: Apr. 9, 2008

Related U.S. Application Data
(60) Provisional application No. 60/922,477, filed on Apr. 9, 2007.

(51) Int. Cl. G06F 9/44

(52) U.S. Cl. 717/106

(57) ABSTRACT

Systems and methods for automatically creating deployable software code for implementing a business process that leverages rules stored in a rule repository, which define a core rule set for the process. The method comprises selecting the rules required to implement the business process. Some of the selected rules are stored in the rule repository, and others may be added by a designer of the process to fit the policies and systems for whom the process is being designed. Next, steps of the business process that require external interfaces (e.g., function calls) are determined. Then, based on, among other things, (i) the selected rules, (ii) the required external interfaces, and (iii) desired outputs of the process, the deployable process code is automatically generated, taking into consideration the interdependencies and implied sequencing of the selected rules. In addition, the inputs to the process can be computed.

### PRIORITY CLAIM

The present application claims priority to U.S. provisional application Ser. No. 60/922,477, filed Apr. 9, 2007, which is incorporated herein by reference.

### BACKGROUND

A common way that companies develop business processes is by starting with a pre-configured process diagram, and then manually customizing the process to fit the business's specific environment. Process diagrams usually require extensive customization because of the unique ways that a company can choose to do business and their specific computing infrastructure. Computing infrastructures can be quite diverse. Some companies have monolithic systems that perform many functions like ERP systems, some have multiple systems, some have fine grain interfaces exposed, and others have coarse grain. This multitude of variations frustrates the ability to apply pre-configured process diagrams universally, and reduces the utility of such diagrams to little more than good starting places to begin process planning.

The process diagram method leaves room for improvement in many ways. For example, once a process is customized for a particular company, it cannot easily be updated, such as in response to regulatory changes. In addition, changes to the process are difficult to affect quickly. Seemingly minor changes may manifest themselves in multiple places within a process. Further, because business processes ordinarily interface with other systems, complex interdependencies frequently will exist that must be considered when implementing changes in the process.

The root cause of these and other problems associated with the process diagram technique stems from processes no longer containing their original requirement information in a form that can enable resilience to change. At one point, the process designers may have known, for example, why two steps in a process were made interdependent or why they decided to make two function calls to complete a particular step instead of one. This logical information is not retained with the process, so the process has little potential to behave resiliently to external or internal change.

### SUMMARY

In one general aspect, the present invention is directed to systems and methods for automatically creating deployable software code for implementing a business process that leverages rules stored in a rule repository, which define a core rule set for the process. According to various embodiments, the method comprises selecting the rules required to implement the business process. Some of the selected rules are stored in the rule repository, and others may be added by a designer of the process to fit the policies and systems for whom the process is being designed. Next, steps of the business process that require external interfaces (e.g., function calls) are determined. Then, based on, among other things, (i) the selected rules, (ii) the required external interfaces, and (iii) desired outputs of the process, the deployable process code is automatically generated, taking into consideration the interdependencies and implied sequencing of the selected rules. In addition, the inputs to the process can be computed based on the data needs of the process.

Processes generated by the present invention can be resilient to change (e.g. regulatory and environmental) because the original requirement information has not been lost. Moreover, because processes are determined by an underlying set of rules, such processes may also be applied to vastly different computing infrastructures. Rules can be added, removed, or modified, and the process will be able to regenerate itself from its rules and bindings. Further, the binding information used to associate the external function calls is inter-combined with the rules in generating the process code. As a result, enterprises implementing automated business processes can leverage a central repository of pre-configured processes, implied by the rules sets stored in the rule repository, and still have unique and customized processes generated in an automated fashion.

These and other benefits of the present invention will be apparent from the description below.

### FIGURES

Various embodiments of the present invention are described herein by way of example in conjunction with the following figures wherein:

FIG. 1 is a diagram of a system according to various embodiments of the present invention;

FIG. 2 is a flowchart of a process according to various embodiments of the present invention;

FIG. 3 is a diagram of an automated business system according to various embodiments of the present invention;

FIG. 4 is a diagram of a semantic graph;

FIGS. 5A and 5B illustrate examples of two different processes that have the same goal; and

FIG. 6 provides a formal definition of a semantic graph according to various embodiments of the present invention.

### DETAILED DESCRIPTION

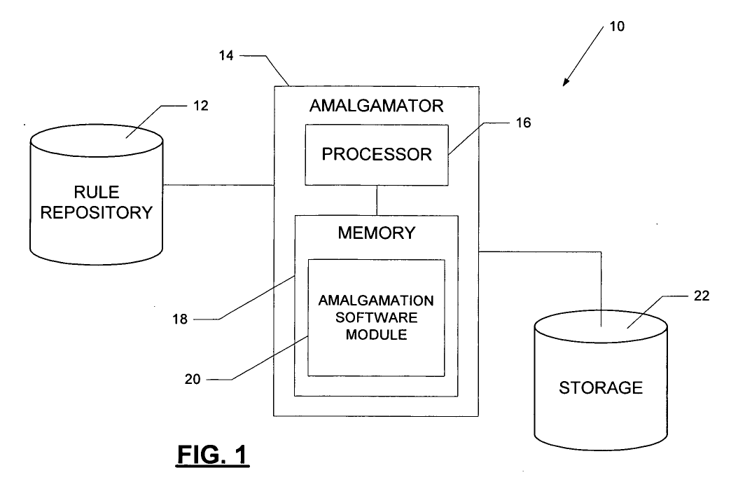

FIG. 1 is a diagram of a system 10 that can aid in the automatic generation of deployable business process code for performing a process that, once generated, can be executed by an engine, such as a rules engine, to implement the process. As shown in FIG. 1, and as described further below, the system may comprise a rule repository 12, which may store rules that imply processes, one or more of which may be sub-processes in the business process to be implemented. In this way, a person or entity looking to implement a particular process can utilize one or more of the rule sets in the rule repository 12, combined with additional rules that are specific to the person's or entity's particular systems, to generate a customized and resilient deployable business process.

The deployable code may be generated by a computer system 14, sometimes referred to herein as an “amalgamator.” Based on (i) the rules stored in the rule repository 12, (ii) other rules that the person or entity may specify, and (iii) associations with external interfaces that some of the rules may require (which are referred to as “bindings”), the amalgamator 14 may automatically create the process, taking into consideration the complex independencies and implied sequencing of the rules. The output of the amalgamation process may be deployable software code, which may be deployable in a business process system to implement the process. The deployable code may also be stored in computer data storage 22.

The rules stored in the rule repository 12 may use (but are not required to use) semantic graphs as their parameters and variables. A semantic graph is a way to package multiple ontological classes and relationships into a new concept, not found within the ontology. An ontology is a data model that represents a set of concepts and the relationships between those concepts. An ontology generally contains classes, instances, and properties (i.e., relations). Semantic graphs for a process are constrained by the classes, instances, and relationships within an ontology.

In various embodiments of the present invention, the ontologies used to constrain the semantic graphs may be defined using the W3C's Web Ontology Language (OWL) specification. A semantic graph can also be viewed as a list of RDF (Resource Description Framework) triples with a “head” concept. RDF is a W3C specification, as described in http://www.w3.org/TR/2004/REC-rdf-primer-20040210/, which is incorporated herein by reference. An RDF triple has a subject, predicate (also called a “property”), and an object. A semantic graph may have other meta-attributes, such as a name for the graph, etc.

Consider this example from (http://www.w3.org/TR/2004/REC-rdf-primer-20040210/):
http://www.example.org/index.html has a creator whose value is John Smith
   This could be represented by an RDF statement having:
a subject http://www.example.org/index.html
a predicate http://purl.org/dc/elements/1.1/creator
and an object http://www.example.org/staffid/85740
   The items descriptions like http://purl.org/dc/elements/1.1/creator are uniform resource indicators (URIs), so the definition is unambiguous. Using URIs allows one to differentiate between multiple meanings of a word.

The use of semantic graphs is not necessary to the invention. Semantic graphs are used primarily to facilitate re-use of repeatedly used concepts that commonly require multiple or constrained ontology classes to model. Instead of semantic graphs, a list of RDF triples could be used and repeated, for example, but this solution would not enable reuse.

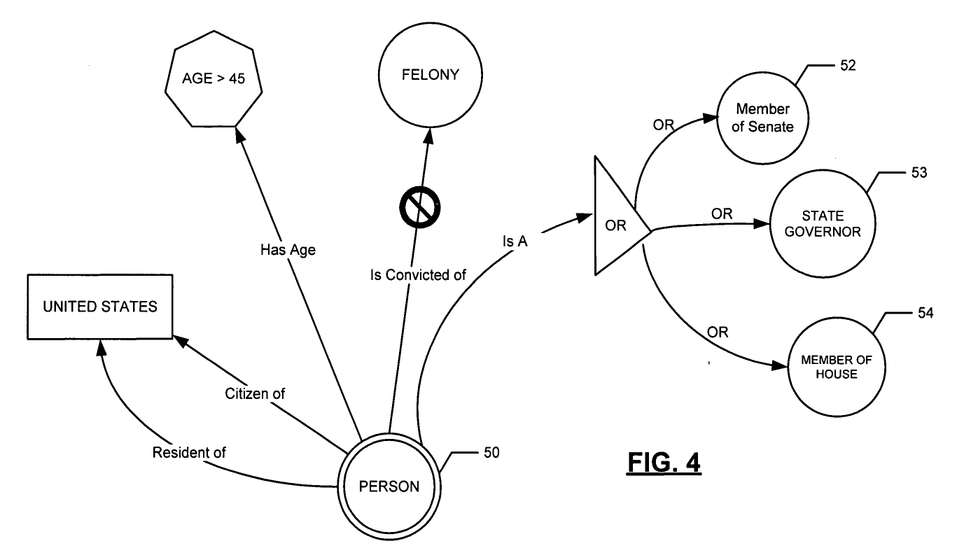

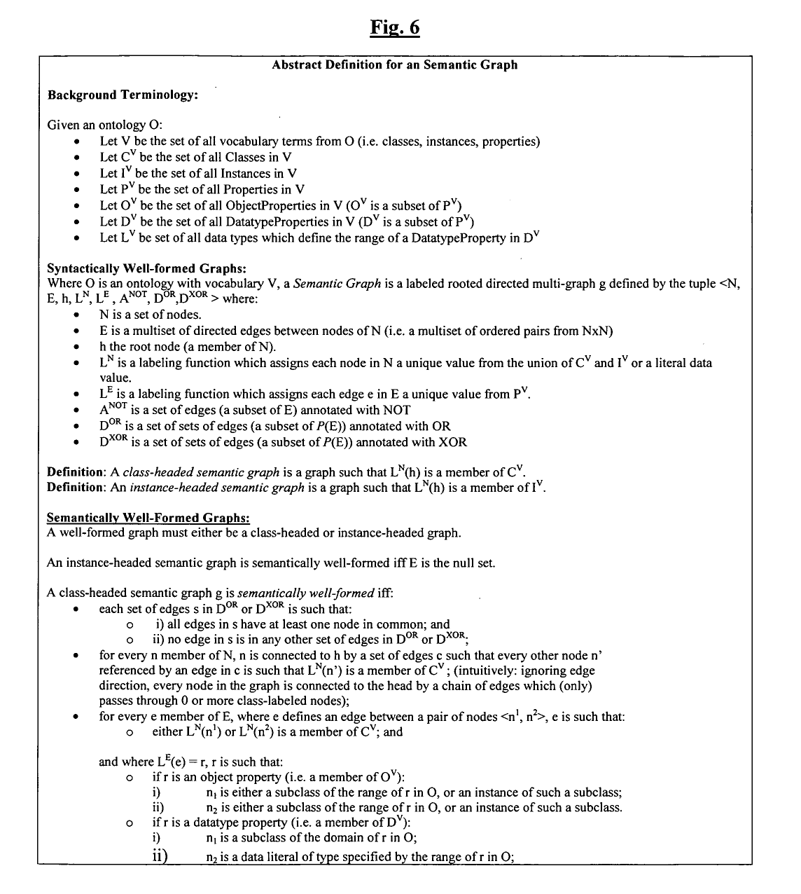

For illustrative purposes, FIG. 4 shows an example of a semantic graph about a person likely to run for United States President that could be used to constrain a variable within a rule. In this example, circles represent classes, rectangles represent instances of classes, and hexagons represent restrictions on literal data values. The “Ø” symbol represents a negated relationship, and the head node of the semantic graph, indicated by a double circle 50, is associated with the ontology class #Person. The graph defines a possible constraint on a rule variable that requires that any entity denoted by the variable be both an instance of #Person and otherwise satisfy the constraints indicated by the graph's structure. Senator, state governor, and house representative are subclasses of the head class, represented by the circles 52-54, respectively. So, according to the graph, a person who is likely to run for president (1) is either a senator, state governor, or house representative, (2) has not been convicted of a felony, (3) is over the age of forty-five, and (4) is a resident and natural born citizen of the U.S. A formal definition of a semantic graph, according to one embodiment, is provided at FIG. 6.

Referring back to FIG. 1, the computer system 14 may comprise one or a number of networked computer devices, such as personal computers, laptops, servers, mainframes, supercomputers, or networks of such devices. The computer system 14 may comprise one or more processors 16 and one or more memory units 18. The memory unit(s) 18 may comprise a suitable type of computer readable media, such as RAM or ROM. In addition, the memory 18 may comprise an amalgamation software module 20. The module 20 may contain instructions or commands, which when executed by the processor 16, cause the processor 16 to automatically generate the deployable process code for the business process. The code generated by the computer system 14 may then be stored in the storage 22. The generated code may also be deployed in the various layers within the architecture implementing the business process.

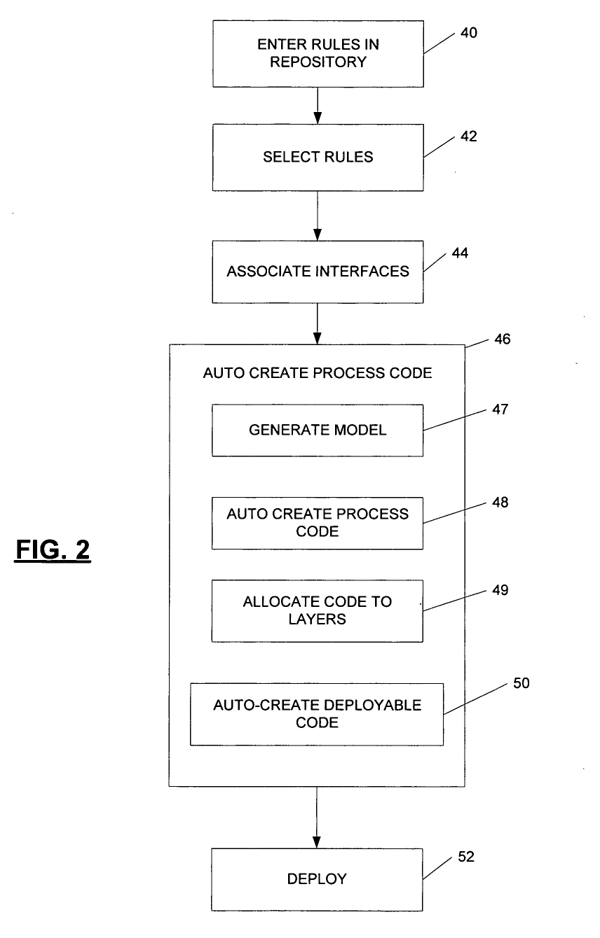

FIG. 2 is a flowchart of how the business process code may be generated according to various embodiments of the present invention. At step 40, rules relating to the process are entered into the rule repository 12. As mentioned above, the rules may (but are not required to) use semantic graphs as their parameters and variables. Next, at step 42, some proper subset of the rules in the rule repository 12 is selected to generate automatically the process. Generally, rules that are related to or necessary for other rules may be selected. The selection process may include human intervention from the person designing the process, especially in the case where a new process is being designed, to make sure the appropriate rules are selected. In cases where a previously configured process is being modified, the user may just add or delete rules as needed based on the desired modification, rather having to reselect all of the relevant rules.

Next, at step 44, steps of the process that, for example, either require data or that perform function calls are associated with interfaces, and the input and output fields of the interfaces are associated with semantic graphs. That is, for example, if a step of the process requires data from an external source, an interface for the source of the data is associated with the step. Similarly, if a step requires a function call that is performed by another system in the network, an interface for calling that function of the other system is associated with the step. The associations between steps and such external interfaces are referred to sometimes herein as “bindings.”

According to various embodiments, the W3C's Web Service Description Language (WSDL) standard may be used to describe the inputs and outputs of function calls. WSDL is an XML-based language that provides a model for describing Web services.

Again, in the case where an existing pre-configured process is being modified, interface associations may be added or deleted as needed. When an interface is added, the amalgamation process will create the new deployable code based on the new interface as needed. When an interface is removed, references to the removed interface may be deleted and/or disabled.

Next, at step 46, based on the rules and bindings (i.e., interfaces), the processor 16, executing the instructions of the amalgamation software module 20, may automatically generate deployable business process code for implementing the desired business process. The generated code takes into consideration the complex interdependencies of the rules of the process as well as the implied sequencing of the rules. According to various embodiments, the generated business process code may be Business Process Execution Language (BPEL) code, JAVA code, or any other suitable code type. The code could be employed, for example, in a rules engine, a complex event-processing engine, or any other suitable engine or system.

Automatically generating the deployable software code may comprise the steps of: (step 47) generating a model process based on the selected rules; the (step 48) automatically creating the process code; (step 49) allocating the code to various processing components of the system that require deployable code; and (step 50) automatically creating the deployable code to match the specified allocation (from step 49). For example, portions of the code may be allocated to the rule engine layer, the process layer, the application layer, etc. As part of this step, for example, the amalgamator 14 may generate the various files needed to deploy the code based on the architecture where it is to be deployed. For example, the amalgamator 14 may generate BPEL files, or use a rule converter, such as a RuleML converter, to generate the appropriate files. Once created, at step 52, the code may be deployed.

It should be recognized that throughout the process the generated process code may be evaluated to see if it is acceptable. If it is not, the process may return to step 42. For example, after the code is generated at step 48 or after the code is allocated to the processing layers at step 49, the code may be evaluated to determine if it is acceptable. If it is, the process may proceed to the next step. If it is not acceptable, the process may return to step 42, 44, or 46 to make sure that the appropriate rules and interfaces (at step 50) for generating the process are selected.

Virtually any process can be viewed as a set of business rules. According to one embodiment of the invention, semantic graphs are used to define the concepts used within both the rules and the bindings. The bindings associate the input and output fields of the interfaces (e.g., WSDLs) with semantic graphs, which determine rule dependency. The amalgamation process can then be used to generate automatically the process, accommodating the complex interdependencies of the rules and their implied sequencing.

Thus, the rule repository 12 can be considered a library of processes that allows the processes to be individually and automatically customized per client. However, rather than storing processes as such, the invention leverages a more modular set of rules which may be traced back to explicit and implicit requirements of the client's regulatory, commercial, and physical environment.

To envision how the process may work, imagine the example of creating a new bank account opening process at BankCo. The rule repository 12 may have a number of rules (e.g. two hundred) that should be part of the process. The client BankCo has many other policies specific to its operations, which add on another fifty rules. Further, BankCo may also have a unique set of both proprietary legacy and vendor purchased systems that need to be interfaced. Using our invention, the process may be automatically generated by amalgamating all 250 rules and inter-combining BankCo's specific bindings. In this way, BankCo can obtain a customized solution that is tailored to its needs (because its specific rules and bindings were used). The majority of the process came from the rules from the rule repository 12 that are core to the process. The core rule set could be shared by a number of clients in the banking industry sector seeking to establish a process for opening a new bank account.

Furthermore, using this same example, if a regulation changes regarding the process of opening new bank accounts, the custodian of the rule repository 12 can add, delete, or modify the rules in the rule repository 12 to keep the rules and the implied processes compliant. As a result, the core rule set for that process may grow from 200 rules to 215 rules. Any clients having processes that were previously generated utilizing these changed rules, or may have an existing process that now needs to include any new added rules, could then regenerate their processes using the new rule set in order to maintain compliance. In the case of BankCo, it would need to amalgamate 265 rules (considering the 50 rules that were specific to it). Depending on what rules were added, it is possible that some of the new rules would require new bindings to be defined and associated.

The ability to re-generate processes when rules change, described above, allows an organization's processes to be resilient to change because the original requirement information has not been lost. Rules can be added, removed, or modified, and the process will be able to regenerate itself. Further, the binding information is inter-combined with the rules in generating the process code. As a result, enterprises implementing automated business processes can leverage a central repository of pre-configured processes, implied by and derived from, the rules sets stored in the rule repository 12, in an automated fashion.

As used herein, a “rule” can be any piece of knowledge or any directive that can be expressed as a rule. This includes, but is not limited to, directives found within Government documents, tacit knowledge of employees, corporate procedures, industry best practices, general “common sense,” and so on. Rules may also include knowledge implicit in graphical artifacts such as org charts, charts, graphs, and process flow diagrams.

In certain cases, usually with a highly structured format or language, it may be possible to extract Rules fully automatically from documents, or with some computer assistance. However, the rule extraction process may also be partially or wholly manual, whereby a human rule builder writes rules based on sections and sentences within documents. When a rule is stored in the rule repository 12, it may be linked to one or more places within some subset of source documents. Because of this linkage, if a source document changes, rules that reference the modified document section(s) can be detected and analyzed to determine whether they need to be changed in view of the changes to the source document. In addition, a natural language version of each rule may be stored when it is entered in the rule repository 12. This allows the processes to be somewhat self-documenting, since each rule can express in natural language what it is doing and what regulation or company procedure it supports.

A traditional IF-THEN rule Has a structure of the generalized form of IF condition THEN consequence. Such rules will generally have input and output variables. A rules consequence is often referred to as its “goal.” For example: IF invoice has been approved AND the invoice's amount is greater than $500, THEN request approval from the Manager. In this rule, the condition is “invoice has been approved AND the invoice's amount is greater than $500” and the consequence is to “request approval from the Manager.” The input variables could include many data items such as the invoice itself, with many sub-fields like requester, approval, and amount. Another input would be the Manager. When the user binds this rule consequence to a real interface, often other elements are required by the interface. For example, the interface may want the employee id of the manager as well. This employee id was never referenced by the rule itself, and may be included only due to the binding chosen. Further, the rule's outputs may include whether the manager approved and an approval ID, for example.

It is common when designing a process to have the designer specify specific return values to be returned from the overall execution of a process to the caller of the process. For example, it may be desirable to have a process that creates an invoice, return the invoice number and an error code to the caller of the process. The amalgamator can use the same binding mechanism to describe the overall process's output variables. These desired overall process outputs are considered by the amalgamator 14 when the process is constructed.

According to various embodiment, a number of rule types may be used, including action rules, assignment rules, constraint rules, ordering rules, and subsumption rules, for example. An action rule performs an action of some type, not just the assignment of a variable. Typically, the action involves calling an external system (such as a web service) to perform an action. The call of an external service will often return values.

An assignment rule can be used to change a value within a process.

A constraint rule does not necessarily perform an action or make an assignment, but rather may serve to restrict an action or assignment rule in some way. A common use would be to restrict the limits of a variable assignment, or to put a restriction on the way an action is executed. An example of such a constraint rule is that emails to the US president from a member of congress must be sent encrypted.

Most rules are ordered automatically by the amalgamator based on dependencies, however there are cases where a specific ordering rule is necessary to disambiguate the ordering of rules. An ordering rule may state that one rule must be executed before another rule if both rules are present in the selected set of rules to be amalgamated. This rule is critical in the case that both rules are dependent on each other. For example, consider if both var1 and var2 are false, the two rules below depend on the order of execution:

Rule 1: Set var1=true if var2=false

Rule 2: Set var2=true if var1=false

If these two rules are executed in sequence, only one of the two variables would be equal to true. If they were executed in parallel, then both variables would be set to true. Obviously, this would be a problem. To help the user, the amalgamator 14 can easily detect these dependencies; however, the user must ultimately resolve them. Therefore, when rules cross depend or are circularly dependent, an explicit ordering rule may be required to state which rule is executed first, or if they should be executed in parallel and ignore the dependency. A circular dependency would occur any time a directed graph of dependencies has a cycle. Consider the example:

Rule 1: Set var1=true if var2=false

Rule 2: Set var2=true if var3=false

Rule 3: Set var3=true if var1=false

In this example, there are no pair-wise dependencies; however, the ordering of the rules clearly matters. Circular dependencies may be detected by creating a dependency graph (or matrix) and looking for cycles. Anywhere a cycle exists, an ordering rule must be used to disambiguate the ordering.

Subsumption rules may define a set of rules that can subsume (i.e., substitute for) another set of rules. For example, there are cases when a rule (or set of rules) is replaced by a set of rules. The normal case would be where a high-level rule is substituted by multiple detailed rules. For example, a rule may say, “Paint the room.” If instead three rules were substituted for this one rule, such as “prepare the wall surface,” “spread the paint on the walls,” and “wait for the paint to dry,” these three rules could be considered a replacement for the “Paint the room” rule. Only the three new rules would be used ordinarily in the process, not all four rules. However, further complicating matters is the fact that while these three new rules may always be considered a full replacement, another rule, such as, “cover the floor with drop cloths,” may also be needed when the replacement is used.

This complexity may be dealt with through the use of subsumption rules. In the case of a complete subsumption, a simple substitution of rules may be performed. A partial substitution probably represents a rule selection error by the user, uncovers a logical error, and was probably not desired. Therefore, the system 14 may warn the user and give the user the opportunity to modify the selected rules set, include a different subsumption rule to eliminate the partial subsumption, or remove the offending subsumption rule from the selected set of rules.

In order to keep track of what events executed during the course of the execution of a process, an event table may be used. The event table may store rule IDs and goal input variables of all the action rules, and return values, so that the future rule conditions can check whether a particular event previously occurred in the execution of the process. Most, if not all, process execution engines have some method for defining and storing process variables that can be referenced during the lifecycle of the process.

The constraint rules may be stored and checked after every rule in order to ensure that a constraint has not been violated. Constraint checking may be optimized by only checking constraints related to potential variable changes. In one embodiment, the process may end prematurely when a constraint violation occurs and a constraint violation failure code may be returned, although in other embodiments, different courses of action may be specified.

Action rules preferably are associated with an interface (e.g., a web service) to call when executed. Each of these interfaces will commonly have input and output variables. A “binding” may be associated for each external function call (e.g. web service call) to: (a) know the format and how to execute the external interface; (b) map the input and output variables to semantic graphs; and (c) know to which action rules the interface may apply (i.e., which action rule goals could match the purpose of the interface). The bindings allow the amalgamator to associate a semantic understanding with an interface. One of the reasons this is important is because the input and output variables of a binding could affect rule dependencies.

Prior to amalgamation, according to various embodiments, the semantic graphs used within a rule may be replaced with their component RDF triples. This normalization step helps to eliminate any construction biases as might arise when a rule builder chooses between writing several conditions which reference multiple, smaller semantic graphs, or writing less conditions which reference fewer, larger semantic graphs, where in both cases they would contain the same underlying RDF triples. This normalization (expansion) must be done properly, which may require nesting of sub-conditions and logical operators.

Once the rules are normalized, there will be a set of input variables that are required for each rule. The input variables would be the variables that are not satisfied by the output of some other rule. To reduce the number of input variables, many processes will initially execute action rules for the purpose of data gathering. These rules can then be bound to a database to retrieve some required data values. Any input variables need to be specified by the caller of the process.

As mentioned above, the amalgamator 14 may take account of explicit and implicit rule sequencing dependencies, and when used to generate a process, it will sequence the rules appropriately based on such dependencies. For example, Rule A is dependent on rule B if any of Rule A's input variables can be changed by the result of Rule B's goal's execution. Said more formally, a rule that is logically dependent on another, may be expressed using conditions and constraints which are semantically subsumed-by, but not identical with those of the other rule. One of the complexities that must be considered is that a Rule A or B may not use the identical class names since the two variables may be super-classes, sub-classes, or an Instance of one another in the ontology. For example, if Rule B has the ability to set the color of an automobile, and Rule A checks if a specific truck is red, these two rules would be computed as dependent even though one is based on the general super class of automobiles and color and the other condition variable references the sub-class of a particular brand of truck and the color red.

After computing the rule dependencies, a dependency graph may be the result. Rules within the dependency graph may fall into the following cases:
1. A rule that does not depend on any other rules, but is a dependency for other rules, may be considered as a starting point in the modeled process.
2. If two rules both depend on the same rule, but do not depend on each other, they can be represented in parallel in the process model.
3. A rule that does not have any rules that depend on it, but is dependent on other rules, is the end point in the process or a branch of the process.
4. A rule that has no dependencies and is not a dependency for any other rule, is a rule that should be flagged and returned as evidence of a potential anomaly within the rule set (e.g. the rule set may be missing rules, or may include rules which are really extraneous to the process being modeled).
5. Two rules that depend on each other should be flagged and returned as an ambiguity unless a sequence rule exists to disambiguate their ordering.
   Subsumption rules can be applied to remove rules where appropriate; if a partial subsumption exists, the user may be warned.

Redundancy subsumption may be when two or more rules are modeled to be run in parallel and only one is needed because they are either identical or one is a subcase of the other. For example, it may be said that A subsumes B if B is a subcase of A. According to various embodiments, the rules may be modeled as follows in the following cases of redundancy subsumption:
1. If Goal 1 is identical to Goal 2, but the conditions are different, these two rules may be merged, and the two sets of conditions may be merged with an “OR” conjunction.
2. If Goal 1 subsumes Goal 2 and Condition 1 is identical (or otherwise determined to be equivalent) to Condition 2, or Condition 1 subsumes Condition 2, then Rule 2 is executed before Rule 1, and Rule 1 is only executed if Rule 2's conditions were not met (i.e. Rule 2's goal didn't “fire”).
3. If Goal 1 subsumes Goal 2 and Condition 2 subsumes Condition 1, Rule 1 may be removed.

Once the process modeling performed by the amalgamator 14 is complete and the variables are computed, the amalgamator may emit the process code. In one embodiment, the model may be translated to BPEL XML files, which may be directly executed by a BPEL process execution engine program, as described further below.

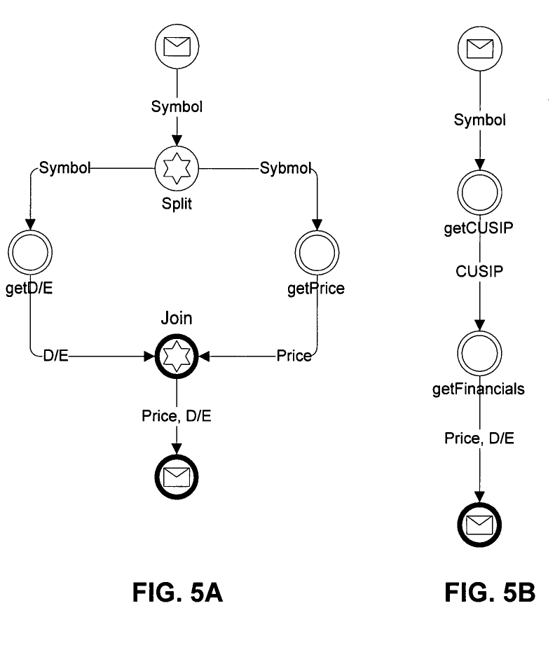

Having now described aspects of the amalgamation process, consider the example where the process to be designed is to retrieve (i) the price and (ii) the debt-to-equity (D/E) ratio for a stock denoted by a stock symbol. In most financial systems, price is real-time information, but D/E ratio is usually only updated quarterly. As a result, these two pieces of information often are stored in different systems or databases. In addition, some stock systems/databases index stocks by ticker symbol, while other systems/databases use CUSIP numbers. As a result, in two different environments, the same process may look substantially different. For example, FIG. 5A shows a process where the D/E ratio and the price are obtained in parallel. FIG. 5B on the other hand shows a process where getCUSIP is called first, and then instead of two calls to get the price and D/E ratio, one service call to getFinancials is used to retrieve both of the values.

Applying either of these process diagrams to the other as a pre-configured solution would not be of much benefit. The amalgamation process described above, however, solves this problem because it uses the relevant rules and bindings to generate the process, considering the complex interdependencies of the rules and their implied sequencing.

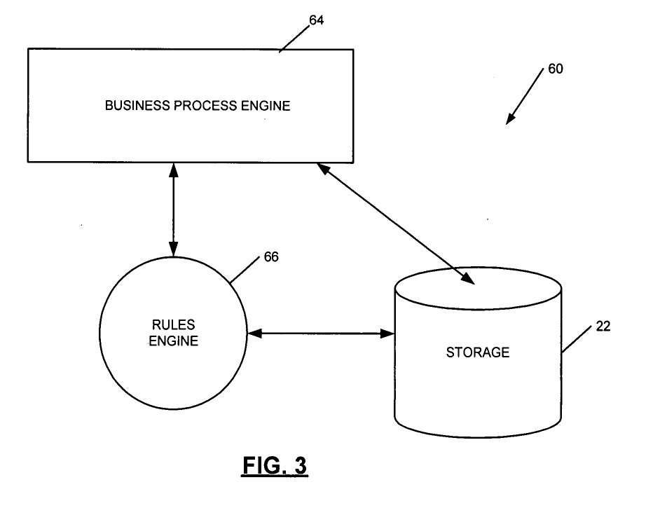

The code generated by the amalgamator 14 may be stored in a computer readable memory storage. The generated code may also be stored for execution at various parts of an automated business system. For example, some of the code could be stored in computer readable media for execution by an engine, such as a rules engine, a complex event processing engine, business process engine, etc., or in some other components of an automated business system. FIG. 3 illustrates an automated business system 60 according to various embodiments. The storage 22 may store the code generated by the amalgamator 14, which may be executed by a rules engine 66, the business process engine 64, or some other type engine, etc. That way, the various coded processes automatically generated by the amalgamator 14 could be integrated in the automated business processes performed by the automated business system 60. In FIG. 3, only one storage 22 is shown, although there may be a number of such storage units distributed throughout the system 60 for storing the code.

The system 60 may utilize an XML-based service oriented architecture (SOA) using industry-standards business process execution language (BPEL), business rules management systems (BRMS) and web services interfaces. In the illustrated embodiment, the rules engine 66 is in communication with a business process engine 64, which may aid in the execution of the automated business processes of an enterprise/business. According to various embodiments, the business process engine 64 may be a commercially available BPEL Process Management software product. When required during the course of the process, the rules engine 66 or the business process engine 64 may invoke the code of the storage 64 to execute a process. The rules engine 66 may be, for example, a commercially available Rules Management software product.

The rule repository 12 may have differing levels of security and/or access for clients. For example, rules specific to one client are preferably restricted from other clients accessing the rule repository 12. Further, in one embodiment, clients in a particular business or industry sector may have access to core rule sets pertinent to their sector, but not have rules sets that are inapplicable to their sector. In other embodiments, different types of tiered access could be employed.

According to other embodiments, to implement the amalgamator 14 to model the rules and emit the deployable code, an inference rules engine could be used to automatically generate the deployable code based on the rules.

According to other embodiments, the amalgamator 14 may not emit the deployable code. In such embodiments, the amalgamator 14 may be in communication with a code generator that produces the deployable code based on the process model, rule interdependencies, input variables, etc., computed by the amalgamator 14. For example, in one such embodiment, the amalgamator 14 could produce its output in a Unified Modeling Language (UML) format, and the code generator may use a UML code generation tool to produce the deployable code. The code generator, therefore, may be computer device that is programmed with appropriate software to produce the deployable code based on the intermediate form output from the amalgamator 14.

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments.

It is to be understood that the figures and descriptions of the embodiments have been simplified to illustrate elements that are relevant for a clear understanding of the embodiments, while eliminating, for purposes of clarity, other elements. For example, certain operating system details for computer systems are not described herein. Those of ordinary skill in the art will recognize, however, that these and other elements may be desirable in a typical processor or computer system. Because such elements are well known in the art and because they do not facilitate a better understanding of the embodiments, a discussion of such elements is not provided herein.

In general, it will be apparent to one of ordinary skill in the art that at least some of the embodiments described herein may be implemented in many different embodiments of software, firmware and/or hardware. The software and firmware code may be executed by a processor or any other similar computing device. The software code or specialized control hardware that may be used to implement embodiments is not limiting. For example, embodiments described herein may be implemented in computer software using any suitable computer software language type, such as, for example, C or C++ using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

While various embodiments have been described herein, it should be apparent that various modifications, alterations, and adaptations to those embodiments may occur to persons skilled in the art with attainment of at least some of the advantages. The disclosed embodiments are intended to include all such modifications, alterations, and adaptations without departing from the scope of the embodiments as set forth herein.

What is claimed is:

1. A computer-implemented method for creating deployable software code for implementing a business process, the method comprising:
selecting rules required to implement the business process, wherein at least some of the selected rules are stored in a rules repository, wherein the rules stored in the rules repository imply at least a part of the business process to be implemented;
determining steps of the business process that require external interfaces; and
automatically generating the deployable software code based on the selected rules and required external interfaces of the selected rules, wherein automatically generating the deployable software code comprises considering the interdependencies of the selected rules and implied sequencing of the selected rules.

2. The method of claim 1, further comprising computing inputs for the process.

3. The method of claim 2, wherein automatically generating the deployable software code includes automatically generating the deployable software code based on a specified output of the process.

4. The method of claim 1, further comprising storing the deployable software code.

5. The method of claim 4, further comprising executing the deployable software code.

6. The method of claim 1, wherein at least one rule of the selected rules uses a semantic graph to define the rule.

7. The method of claim 1, wherein at least one rule of the selected rules uses a Resource Description Framework triple to define the rule.

8. The method of claim 1, wherein at least one rule of the selected rules has a rule type selected from the group consisting of an action rule, an assignment rule, a constraint rule, an ordering rule, and a subsumption rule.

9. The method of claim 1, wherein automatically generating the deployable software code comprises:
computing a model of the process;
computing rule dependencies;
computing input variables for the rules; and
emitting the deployable process code.

10. The method of claim 1, wherein the required external interfaces of the selected rules comprise at least one function call.

11. The method of claim 10, wherein the function call comprises a web services function call.

12. The method of claim 10 wherein the function call uses Web Service Description Language (WSDL) standard to define an input and an output of the function call.

13. A system for creating deployable software code for implementing a business process, the system comprising:
a rule repository that stores rules that imply at least a part of the business process to be implemented; and
a computer device in communication with the rule repository, wherein the computer device is programmed to automatically generate the deployable software code based on (i) selected rules for the process, wherein the selected rules comprise rules stored in the rule repository and (ii) external interfaces required by the selected rules, considering the interdependencies of the selected rules and implied sequencing of the selected rules.

14. The system of claim 13, wherein the computer device is further programmed to compute inputs for the process.

15. The system of claim 14, wherein the computer device is programmed to automatically generate the deployable software code based on a specified output of the process.

16. The system of claim 13, wherein at least one rule of the selected rules uses a semantic graph to define the rule.

17. The system of claim 13, wherein at least one rule of the selected rules uses a Resource Description Framework triple to define the rule.

18. The system of claim 13, wherein at least one rule of the selected rules has a rule type selected from the group consisting of an action rule, an assignment rule, a constraint rule, an ordering rule, and a subsumption rule.

19. The system of claim 13, wherein the computer device is programmed to automatically generate the deployable software code by:
computing a model of the process;
computing rule dependencies;
computing variables for the rules; and
emitting the deployable process code.

20. The system of claim 13, wherein the deployable process code comprises BPEL code.

21. The system of claim 13, wherein the required external interfaces of the selected rules comprise at least one function call.

22. The system of claim 21, wherein the function call comprises a web services function call.

23. The system of claim 22, wherein the function call uses Web Service Description Language (WSDL) standard to define an input and an output of the function call.

24. A system for creating deployable software code for implementing a business process, the system comprising:
a rule repository that stores rules that imply at least a part of the business process to be implemented; and
a computer device in communication with the rule repository for computing a model of the process and input variable for the process, based on interdependencies of selected rules, implied sequencing of the selected rules, and external interfaces required by the selected rules, wherein the selected rules comprise rules stored in the rule repository; and
a code generator in communication with the computer device for automatically generating the deployable software code based on output from the computer device.
